(19) United States
(12) Patent Application Publication
(10) Pub. No.: US 2003/0126409 A1
(43) Pub. Date: Jul. 3, 2003

(54) Store sets poison propagation

(76) Inventors: Toni Juan, Barcelona (ES); George Chrysos, Milford, MA (US); Chris Gianos, Sterling, MA (US); Eric Borch, Shirley, MA (US)

Correspondence Address: CONLEY ROSE, P.C., P. O. BOX 3267, HOUSTON, TX, 77253-3267, US

(21) Appl. No.: 10/034,219

(22) Filed: Dec. 28, 2001

(51) Int. Cl. G06F 9/00

(52) U.S. Cl. 712/216; 712/225

(57) ABSTRACT

A microprocessor embodies a poisoning technique with regard to load and store instructions that are related through a common memory reference. The microprocessor includes “store sets” that are created for loads and stores that share a common memory reference and that must execute in program order. The store sets include a value that points to a poison bit in a store set poison table that indicates whether a store instruction that is part of the store set is poisoned by a load instruction that prior to the store. If the store instruction is poisoned, a subsequent store set related load instruction will also be poisoned. That is, the present technique causes poison to propagate from a parent store to a subsequent memory reference dependent load using a store set.

### CROSS-REFERENCE TO RELATED APPLICATIONS

This disclosure is generally related to U.S. Pat. No. 6,108,770 entitled “Method and Apparatus for Predicting Memory Dependence Using Store Sets,” incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention generally relates to microprocessors. More particularly, the present invention relates to preventing order-dependent instructions from executing out of order in an “out of order” processor.

2. Background of the Invention

In general, a computer operates by its microprocessor executing software instructions. The instructions may require data to be stored in or read from memory. In this disclosure, a “load” instruction is the process of reading data from a location in memory and a “store” instruction is the process of storing a data value into a memory location.

Many modem microprocessors allow instructions to execute in an order that is different from program order. Out of order processing permits instructions to be processed more efficiently with respect to processor resources. Some instructions, however, cannot be executed out of order. In particular, some instructions may still require certain dependencies, such as register and memory dependencies, to be preserved. A register dependency results from an ordered pair of instructions where the later instruction needs a register value produced by the earlier instruction. A memory dependency results from an ordered pair of memory instructions where the later instruction reads a value stored in memory by an earlier instruction.

On one hand, the out-of-order execution of instructions generally improves performance because it allows more instructions to complete in the same amount of time by efficiently executing independent operations. However, as explained below, problems may occur when executing load and store instructions out-of-order.

When a load instruction executes before an older, i.e., in program order, store instruction referencing the same address, the load may retrieve an incorrect value because the data the load should use has not yet been stored at the address by the store instruction. There are a variety of techniques to address this problem. For instance, hardware traps and recovery operations can be implemented. In this technique, hardware logic within the processor detects this memory dependency violation, and “squashes” the load instruction and all subsequent dependent instructions. That is, the load instruction, which executes too early, is ignored and must be re-executed (replayed). Other instructions which use the load data may also need to be reprocessed. Because valuable time and resources have been wasted, such hardware recovery degrades processor performance.

Because traps can greatly reduce the performance of a running program, memory dependence prediction techniques have been proposed. These techniques delay certain loads from issuing until certain prior stores have issued. U.S. Pat. No. 6,108,770 entitled “Method and Apparatus for Predicting Memory Dependence Using Store Sets” describes such a prediction mechanism that improves performance by reducing the number of load/store ordering traps.

Superscalar processors today typically have relatively long pipelines through which instructions are processed. A large number of pipeline stages result from reducing the amount of work done per pipeline stage, decreasing the clock cycle time, and boosting clock frequency for high performance. Typically, in heavily pipelined microprocessors, the outcome of a load lookup in the first level data cache is not known for several cycles. To minimize the latency of a load instruction's delivery of data to its subsequent dependent instructions, the dependent instructions are sometimes issued speculatively (i.e., before the outcome of the instruction on which they depend is known). The processor may have a predictor to determine when the dependent instructions should be issued speculatively, or the dependent instructions may always be issued speculatively. If the load hits in the data cache, the data is delivered in minimum time, but if the load misses, the effect of the speculatively issued instructions needs to be erased. It should be noted that the speculatively issued instructions can be directly dependent on the load, or they can be dependent on the dependent instructions, and so on. To erase the effects of all the load's dependent instructions, a hardware trap and recovery mechanism can be employed for all instructions after the load. This approach would drastically impact performance, so subtler recovery techniques have been adopted.

“Poisoning” effectively tracks just those instructions that are register dependent on the load, and, when necessary, sends them back to the instruction queue for reconsideration by the instruction scheduler at a later time. Combining a memory dependence predictor with the “poisoning” technique creates a potential performance divot resulting in repeated store/load order traps. This occurs because the poisoning mechanism typically works via register dependencies, not through memory dependencies. That is, poisoning is not currently available for memory address related, dependent instructions.

The following is an example of this problem. A store may issue. Then, a load that is correctly predicted to depend on the store issues (they are dependent through memory). Later, the store is stopped and reissued because it was register data dependent on a different load that missed in the data cache. Since the original load is not dependent on the store via a register dependence, it is not stopped and reissued, and thus has retrieved the wrong memory value. Finally, a memory ordering trap occurs due to an error in the memory access order even though the memory dependence predictor was correct.

The source of the problem is that the memory instructions that are predicted to be dependent do not have a register dependence between them. If the source of the memory dependence is stopped and reissued the destination(s) will never be notified (because the notification mechanism uses only register data dependencies to find out what instructions have to be stopped and later reissued) and will get to the memory before the producer of the data causing a memory trap.

A solution to the aforementioned problem is needed.

### BRIEF SUMMARY OF THE INVENTION

The problems noted above are solved by a microprocessor which embodies a poisoning technique with regard to load and store instructions that are related through a common memory reference. The preferred embodiment of the microprocessor includes “store sets” that are created for loads and stores that share a common memory reference and that must execute in program order. A store set is identified by a value called a “store set ID.” Loads and stores that are numbers of a store set have a valid store set ID. For a store that is in a store set, the corresponding store set ID indexes a store set poison table that indicates whether a store instruction was poisoned by a load instruction that was fetched prior to the store. If the store instruction is poisoned, a subsequent store set related load instruction will also be poisoned. That is, the present technique causes poison to propagate from a parent store to a subsequent memory reference dependent load using a store set.

### BRIEF DESCRIPTION OF THE DRAWINGS

For a detailed description of the preferred embodiments of the invention, reference will now be made to the accompanying drawings in which:

FIG. 1 is a block diagram showing the typical stages of a processor's instruction pipeline;

FIG. 2 is a schematic diagram showing an instruction stream as it enters the instruction queue of FIG. 1;

FIG. 3 is a schematic diagram illustrating a re-ordered execution order of the instruction stream of FIG. 2;

FIG. 4 is a schematic diagram illustrating the executed instruction stream of FIG. 3 before and after an instruction squash;

FIG. 5 is a schematic diagram illustrating dependent loads and stores in an instruction stream, with the associated store sets of the present invention;

FIG. 6 is a schematic diagrams illustrating the preferred embodiment of the present invention which employs a store set poison table;

FIG. 7 shows an exemplary set of program instructions; and

FIG. 8 illustrates the sequence of events in ensuring the correct ordering of the instructions from FIG. 7 in light of the preferred embodiment of the invention.

### NOTATION AND NOMENCLATURE

Certain terms are used throughout the following description and claims to refer to particular system components. As one skilled in the art will appreciate, computer companies may refer to a given component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device “couples” to a second device, that connection may be through a direct electrical connection, or through an indirect electrical connection via other devices and connections. To the extent that any term is not specially defined in this specification, the intent is that the term is to be given its plain and ordinary meaning.

### DETAILED DESCRIPTION OF THE PREFERRED EMBODIMENTS

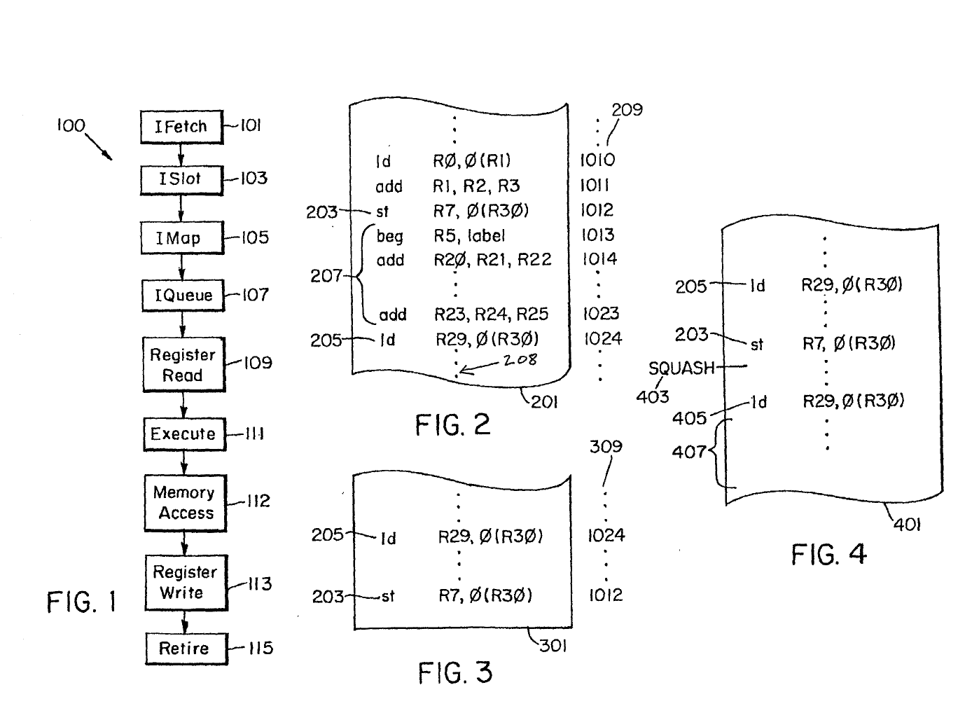

FIG. 1 shows the various stages of a typical microprocessor instruction pipeline 100. The microprocessor 100, as for most microprocessors, comprises the central processing logic of a computer system. The system may include numerous other components, such as memory and input and output devices, coupled to the microprocessor as would be understood by those of ordinary skill in the art.

In instruction stage 101, one or more instructions are fetched, typically from an instruction cache. Next, in the decoder stage 103, the instructions are decoded. In stage 105, architectural registers named in the instructions are mapped to physical registers. Instruction identifiers are assigned to instructions during this stage.

In stage 107, instructions are written into the instruction queue. The instruction queue decides which instructions are to issue based on available resources such as registers and execution units, and on register or store set dependencies, and re-orders the instructions accordingly, assigning the issuing instructions to execution units. This stage makes it possible for instructions to issue in an order that differs from program order.

Next, in stage 109, any registers are read as required by the issued instructions. In stage 111, the instructions are executed. Any memory references which must be derived are calculated during this stage. Stage 112 is the memory access stage in which memory addresses derived in stage 111 are accessed. In stage 113, data is written into the registers. Finally, in stage 115, instructions are “retired.”

The preferred embodiment of the invention combines two concepts—“poisoning” and “store sets” in order to ensure the “validity,” of data targeted by a load that is directed to a memory location common to a previous store. By “validity,” it is meant that the data is not stale (i.e., the data retrieved corresponds to the most recently stored value to that memory location). As explained previously, poisoning has been used to mark or otherwise identify certain instructions as having unreliable data for subsequent register dependent instructions. For example, a load instruction may be issued that is to retrieve data into a register. If the load misses in the cache, the data is not retrieved and the load will have to be retried at a later time. If a store instruction issues that is to store the contents of the same register to memory, the store instruction must be alerted in some way that the contents of the register are not yet ready to be written to memory because the load has not yet executed. Accordingly, the load instruction poisons itself and the subsequent store instruction detects the poison status of the load and the store will be retried after the load has executed. The conventional poison technique generally applies only to instructions that are inter-related via registers (i.e., instructions that use the same register as in the example above). Conventional poisoning techniques do not apply to memory reference related instructions.

“Store sets” represent a mechanism that helps ensure that loads and stores that must be executed in program order are, in fact, executed in the correct order. In general, this technique uses one or more tables which are used by load instructions to determine whether a store instruction must execute before the load and, if so, which store instruction. One exemplary embodiment of a store set is described in commonly owned U.S. Pat. No. 6,108,770 entitled “Method and Apparatus for Predicting Memory Dependence Using Store Sets,” incorporated herein by reference.

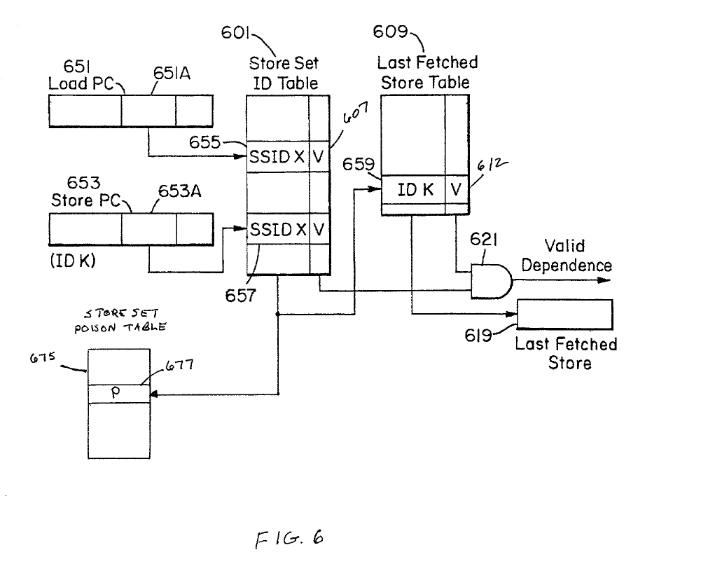

In accordance with the preferred embodiment of the invention, the concept of poisoning has been extended to store sets to solve the problem described above. The following discussion first introduces the concept of store sets (FIGS. 2-5) and then explains how poisoning is incorporated into the store set methodology (FIG. 6). To a large extent, the store set explanation parallels the discussion in U.S. Pat. No. 6,108,770.

FIG. 2 shows an instruction stream 201 as it enters the instruction queue 107 (FIG. 1). Instructions are placed in the queue in the order in which they are encountered in the stream 201. The instruction labeled 203, “st R7,0(R30)” is a store instruction. When it is executed at stage 111 of FIG. 1, the data in register R7 is stored in a target memory location whose address is the sum of 0 and the contents held in register R30. This target address must be computed during the execution stage 111 of the instruction pipeline 100.

The instruction labeled 205, “ld R29,0(R30)” is a load instruction. When it is executed at stage 111 in FIG. 1, the memory location is referenced whose address is again the sum of 0 and the contents held in register R30, and the data held in this referenced memory location is loaded into register R29. Other instructions 207 may be fetched between store instruction 203 and load instruction 205, and of course, additional instructions 208 may be fetched after instruction 205. When the value held by register R30 references the same physical memory location for both instructions 203, 205, the load instruction 205 is dependent on the store instruction 203 because the load instruction 205 needs to read the data stored in memory by the store instruction 203.

As instructions from stream 201 enter the queue 107, they are assigned instruction identifiers 209, here shown in decimal form. Specifically, a value of 1012 has been assigned as the instruction identifier to the store instruction 203, and a value of 1024 has been assigned as the instruction identifier to the load instruction 205.

As stated above, depending on available resources and register dependencies, instructions are issued out-of-order from the instruction queue 107. An execution order of instructions 301 is depicted in FIG. 3. Here the load 205 and store 203 instructions have executed out of program order. This could be, for example, because register R7 is not yet available to the store instruction 203. In any event, if register R30 contains the same value for both instructions 203, 205, the load instruction 205 will potentially be reading in the wrong data because it needs the data to be stored by the store instruction 203.

This out-of-order load/store pair is detected when the store 203 executes. The load instruction 205 and the instructions 208 (FIG. 2) issued after it are squashed and re-issued. Note that the instruction identifiers 309 previously assigned stay with the instructions after re-ordering.

FIG. 4 depicts the issued instructions 401 before and after an instruction squash. The same out-of-order instructions 203, 205 shown in FIG. 3 are shown in FIG. 4. The out-of-order execution is detected as the store instruction 203 issues, and the load instruction 205 and its subsequent instructions 208 (FIG. 2) are squashed at 403. After the store 203 has executed, it is safe for the load 205 to execute and it is re-issued at 405 along with the subsequent instructions 407 corresponding to instructions 208.

Within the context of load/store memory order dependencies and instruction reissuing, the concept of store set is based on two underlying assumptions. The first is that the historic behavior of memory-order violations is a good predictor of memory dependencies. The second is that it is beneficial to predict dependencies of loads where one load is dependent on multiple stores or multiple loads depend on the same store. The present invention provides these functions with direct-mapped structures or tables which are time and space-efficient in hardware.

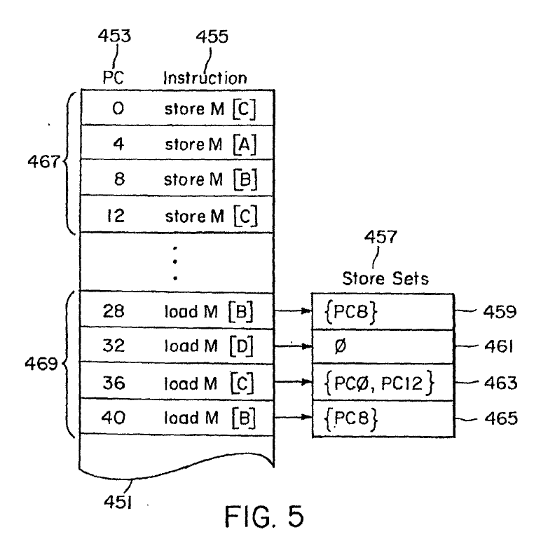

FIG. 5 illustrates how the store sets of the present invention are associated with dependent loads and stores in an instruction stream 451 before reordering. Loads 469 and stores 467 are identified by their program counters (PCs) 453. Each instruction 455 is shown with its corresponding program counter 453, and an indication such as M[A], for example, which represents an access to memory location A.

Each load instruction 469 is associated with a set of store instructions. For a given set of store instructions, the respective PCs of the store instructions in the set form a store set 457 of the associated load instruction 469. A load's store set 457 consists of every store PC that has caused the load to suffer a memory-order violation in the past. Assuming that the loads 469 tend to execute before the prior stores 467, causing memory-order violations, then the store sets 457 have been filled in accordingly as illustrated in FIG. 5.

In particular, the load instructions 469 indicating “load M[B]” are associated with store instruction 467 stating “store M[B].” The program counter 453 of this store instruction is PC 8 in the illustrated example. The respective store sets 459, 465 of the associated load M[B] instructions (at PC 28 and 40) thus each have an element “PC 8.” Likewise, load instructions 469 “load M[C]”(at PC 36) is associated with store instructions “store M[C]” at PC 0 and PC 12. The store set 463 for that load instruction (PC 36) thus has elements “PC 0” and “PC 12.” The load instruction at PC 32 has no associated store instruction and thus has an empty store set 461.

When a program begins executing, all of the loads have empty store sets 457, and the processor allows full speculation of loads around stores. For example, when load PC 36 and store PC 0, both of which access some memory address C, cause a violation by executing in the wrong order, the store's PC 0 is appended to the store set 463 of the associated load (at PC 36). If another store, e.g., PC 12, conflicts with that same load (PC 36), that store's PC is also added to the associated load's (PC 36) store set 463. The next time the processor sees that load (PC 36), the load is delayed from execution only until after execution of any recently fetched stores identified in the load's store set 463. In the depicted example, the processor executes load PC 36 only after store PC 0 or PC 12, assuming either store has been recently fetched.

When a load 469 is fetched, the processor determines which stores in the load's store set 457 were recently fetched but not yet issued, and creates a dependence upon those stores. Loads which never cause memory-order violations have no imposed memory dependencies, and execute as soon as possible. Loads which do cause memory-order violations become dependent only on those prior stores upon which they have depended in the past.

If a store PC 8 in the store set 459 of load PC 28 causes a memory-order violation with a second load PC 40, it (the store PC 8) becomes part of that load's store set 465 also.

Note that a load can have multiple store dependencies, for example, the load at PC 36 depends on the stores at PC 0 and PC 12. Furthermore, multiple loads can depend on the same store. For example, the loads at PC 28 and 40 both depend on the store at PC 8. Because store sets 457 allow a load to be dependent on multiple stores, it would theoretically be necessary to have a mechanism that delayed the load until all the stores in the store set had executed. However, constructing such a mechanism can be expensive. It is preferable to make the load dependent on just one of those stores, yet it is not known which of the load's store dependencies will be the last to execute.

In a preferred embodiment, stores indicated within a store set 457 must execute in program order. This is accomplished by making each of the stores indicated in a given store set 457, dependent on the last fetched store indicated in the store set 457. Each store specifies one dependence and each load specifies one dependent to form an in-order chain resulting in correct program behavior. By requiring that the stores indicated in a store set 457 execute in order, the preferred embodiment of the present invention eliminates the need for complicated write-after-write hazard detection and data forwarding. If two sequential stores to location X are followed by a load to location X, the load effectively depends only on the second store in the sequence. Since ordering within store sets 457 is enforced, special hardware is not needed to make this distinction.

The combination of poisoning with a store set will now be described with regard to FIG. 6. FIG. 6 is a diagram of a preferred embodiment of the present invention comprising three tables. Two of the tables, 601 and 609, are used to implement a store set, while the third table 675 is used to implement poison in conjunction with the store set. First, the use of the store set-related tables 601 and 609 will be described and then the poison table 675 will be discussed.

Table 601 comprises a PC-indexed table called a Store Set Identifier Table (SSIT). A recently fetched load accesses the SSIT 601 based on the load's PC 651 and reads its store set identifier (SSID) 655 from the SSIT 601. If the load 651 has a valid SSID, as indicated by valid bit 607, then it has a valid store set.

The valid SSID 655 points to an entry 659 in a second table 609, the Last Fetched Store Table (LFST). The value stored in the LFST entry 659 identifies a store instruction 619 which is part of the load's store set if the corresponding valid bit 612 is set. This store instruction 619 is the most recently fetched store instruction from the load's store set. Validity of the outputs of both tables 601, 609 is checked by an AND gate 621.

A subsequently fetched store 653 also accesses the SSIT 601. If the store 653 finds a valid SSID 657, then the store 653 belongs to a valid store set of an associated load. The store 653 preferably then does two things. First, it accesses the LFST 609 using the valid SSID index 657 from table 601 and retrieves from LFST entry 659 a pointer to the most recently fetched store instruction 619 in its store set. The new store 653 is made dependent upon the store 619 pointed to in the LFST 609 and informs the scheduler (stage 107 of FIG. 1) of this dependency. Second, the LFST 609 is updated by inserting the identifier of the new store 653 at entry 659, since it is now the last fetched store in that particular store set. In the example of FIG. 6, the identifier for store 653 is ID K which is the instruction number for store 653.

Referring still to FIG. 6, the mechanism for memory dependence prediction using these tables will now be described. Assume that at the start of a program, all entries in the SSIT 601 are invalid. Initially, store and load instructions access the table 601 and get no valid memory dependence information. If a load 651 commits a memory-order violation with a store 653, a store set is created in the SSIT 601 for that load 651. The load 651 and store 653 instructions involved in the conflict are assigned a store set identifier, say SSID X. SSID X is written into two locations in the SSIT 601: the first location 655 is indexed by an index portion 651A of the load PC 651, and the second location 657 is indexed by an index portion 653A of the store PC 653.

The next time that store 653 is fetched, it reads the SSIT entry 657 indexed by the store's 653 PC. Since the store set's SSID 657 is valid, it is used to access the LFST 609 where, if no valid entry 659 exists for store set X, store 653 is not made dependent on another store. In this case, the store 653 proceeds to write its own instruction instance identifier K into the LFST 609 at location 659 as shown. When the load instruction 651 is subsequently fetched, it accesses the SSIT 601, reads store set ID X from location 655 and then accesses the LFST 609 with SSID X. The LFST 609 conveys to the instruction scheduler that the load 651 is dependent upon the instruction whose identifier is indicated at the table entry 659. Thus, this time the instruction scheduler will impose a dependence between the load 651 and store 653 due to entry 659 now indicating instruction identifier K (the store's 653 instruction number).

In connection with the previously described store set implementation, a poison technique is also implemented using table 675. The use of the poison table 675 helps the processor to detect those issued load instructions that the store set caused to issue in correct program order relative to various store instructions, but that must be re-processed nonetheless because the parent store instructions were never executed due to a problem in their hierarchy chain. For example, a parent store may not have executed because its parent load instruction was poisoned which propagated to the store. The store issued, but in a poisoned state signaling to the processor that the store must be re-processed. Because a store may initially issue (albeit in a poisoned state), the store set feature described above would permit an offspring load to issue-the store set feature generally only ensures that dependent loads and stores issue in program order.

The store set poison table 675 is used to determine the trustworthiness of data retrieved by an issued load. In particular, using the table 675, it can be determined whether a store instruction that must executed before a load has been poisoned. If the parent store is poisoned, then the processor determines that the offspring load must be re-processed. In accordance with the preferred embodiment in FIG. 6, once a store instruction becomes poisoned via, for example, conventional register-dependent poisoning techniques, the store instruction sets a value in the store set poison table 675 to indicate that the store has been poisoned. That value may be a single bit that is set to a “1” state to indicate a poison condition. As such, a “0” state for the poison bit preferably indicates the store is not poisoned. Alternatively, an opposite logic polarity of the poison bit can be adopted to indicate the poison status of a store instruction.

When a fetched load instruction 651 subsequently accesses the SSIT 601 based on the load's PC 651 and reads its SSID 655 from the SSIT 601. The SSID 655 is used to point to a corresponding entry 677 in the store set poison table 675. The poison bit entry 677 indicates whether the store instruction that is part of the load's store set has been poisoned. If the poison bit 677 is set, then the scheduler is informed that the load instruction must be re-processed. If the poison bit is not set, then load is permitted to complete.

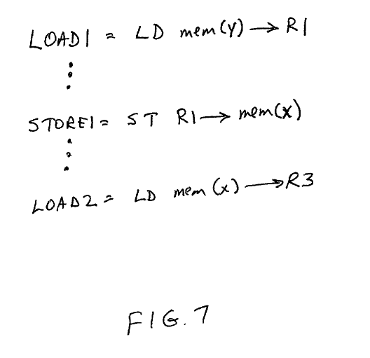

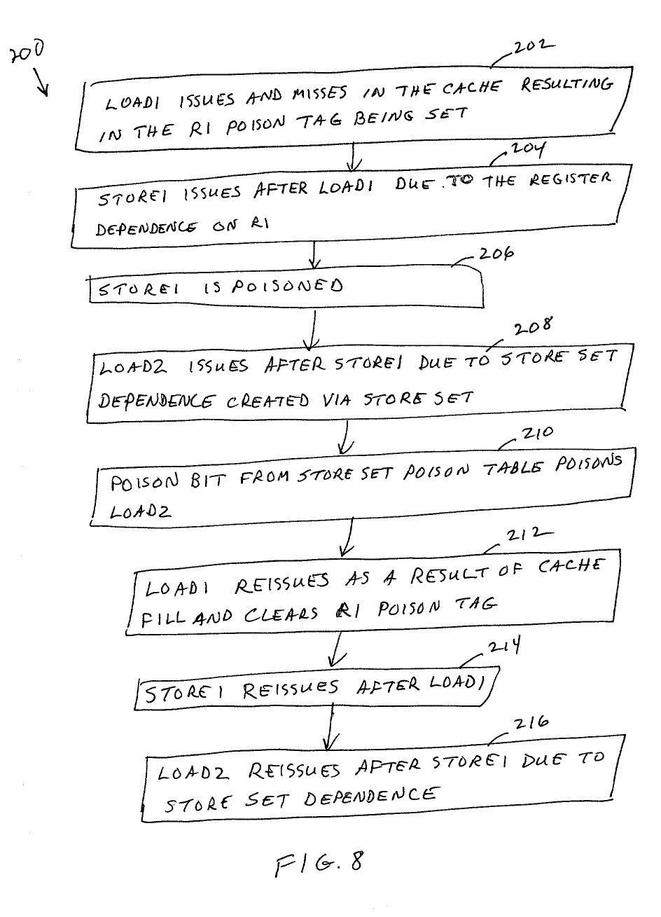

This process is further illustrated in FIGS. 7 and 8. In FIG. 7, three instructions from a program are shown in program order—LOAD1, STORE1, and LOAD2. Other instructions may be included before, between and after these instructions. The LOAD 1 instruction causes the value at memory location Y to be loaded into register R1. The STORE1 instruction causes the contents of registers R1 to be stored in a memory location X. The LOAD2 instruction causes the value at memory location X to be loaded into register R3. As shown, LOAD1 and STORE1 are related by way of register R1 and thus have a register dependence. The STORE1 and LOAD2 instructions are related by memory location X.

FIG. 8 illustrates the sequence of events 200 that will occur to ensure that the three instructions are issued and executed in the correct order. In step 202, the LOAD1 instruction issues and misses in the cache resulting in the poison tag associated with register R1 being set. This poison tag is in accordance with conventional poisoning techniques based on register dependence. In step 204, the STORE1 instruction issues after LOAD1 due to the register dependence on R1, which can be determined when the instructions are fetched as noted above. Because LOAD1 has been poisoned, the STORE1 instruction is also poisoned in step 206. That is, in accordance with conventional poisoning techniques, poison is propagated from a parent load instruction to its register dependent offspring store instruction.

In step 208, LOAD2 issues after STORE1 due to the store set dependence that was created as described above. However, the store sets poison table 675 is used to poison LOAD2 by propagating the poison information through the store set dependence (step 210). In step 212, the LOAD1 instruction reissues as a result of a cache fill and clears the register R1 poison tag. This permits the STORE1 instruction to then reissue in step 214 due to the register dependence on R1. Finally, the LOAD2 instruction reissues (step 216) due to the store set dependence with respect to STORE1.

In this way, STORE1 and LOAD2 are issued and execute in the correct order and their target data is trustworthy. Moreover, no hardware traps occur.

The above discussion is meant to be illustrative of the principles and various embodiments of the present invention. Numerous variations and modifications will become apparent to those skilled in the art once the above disclosure is filly appreciated. It is intended that the following claims be interpreted to embrace all such variations and modifications.

What is claimed is:

1. A method of processing instructions in a microprocessor, comprising:
(a) fetching instructions from an instruction memory, certain fetched instructions being load instructions (loads) and causing load operations, and other fetched instructions being store instructions (stores) and causing store operations;
(b) executing the fetched instructions out of program order;
(c) detecting a load/store order violation wherein a load executes prior to a store on whose data the load depends;
(d) creating a store set for the load;
(e) adding the store to the store set;
(f) determining whether the store is poisoned by a previously poisoned instruction;
(g) if the store is poisoned, setting a poison value that indicates that the store is poisoned; and
(h) re-processing said load if said poison value associated with said store indicates the store has been poisoned.

2. The method of claim 1 wherein (g) includes setting a bit in a table.

3. The method of claim 1 wherein the store set includes a pointer that points to the poison value.

4. The method of claim 1 wherein said store set includes a pair of tables which are used to identify said store instruction.

5. The method of claim 4 further including clearing said poison value when said store is no longer poisoned.

6. A method of processing a store instruction (store) to execute before a load instruction (load) that target a common memory location, comprising:
(a) determining if the data to be written by said store is stale;
(b) if said data is stale, setting a value associated with said store; and
(c) if said value is set, re-processing said load to execute after said data is no longer stale.

7. The method of claim 6 further including establishing a store set for said load to include said store.

8. The method of claim 7 further including using said store set to access said value.

9. The method of claim 6 wherein said value comprises a poison bit.

10. A computer system, comprising:
a microprocessor;
an input device coupled to said microprocessor; and
memory coupled to said microprocessor, said memory containing executable instructions;
wherein said microprocessor:
fetches instructions from said memory, certain fetched instructions being load instructions (loads) and causing load operations, and other fetched instructions being store instructions (stores) and causing store operations;
executes the fetched instructions out of program order;
detects a load/store order violation wherein a load executes prior to a store on whose data the load depends;
creates a store set for the load;
adds the store to the store set;
determines whether the store is poisoned by a previously poisoned instruction;
if the store is poisoned, sets a poison value that indicates that the store is poisoned; and
re-processes said load if said poison value associated with said store indicates the store has been poisoned.

11. The system of claim 10 wherein said poison value comprises a bit in a table.

12. The system of claim 10 wherein the store set includes a pointer that points to the poison value.

13. The system of claim 10 wherein said store set includes a pair of tables which are used to identify said store instruction.

14. The method of claim 13 wherein said microprocessor clears said poison value when said store is no longer poisoned.

15. A computer system, comprising:
a microprocessor; and
memory coupled to said microprocessor, said memory containing a store instruction (store) and a load instruction (load) that target a common memory location;
wherein said microprocessor:
fetches said load and store;
determines if the data to be written by said store is stale;
if said data is stale, sets a value associated with said store;
if said value is set, re-processes said load to execute after said data is no longer stale.

16. The system of claim 15 wherein said microprocessor establishes a store set for said load to include said store.

17. The system of claim 16 wherein said microprocessor uses said store set to access said value.

18. The system of claim 15 wherein said value comprises a poison bit.

19. A microprocessor, comprising:
a fetch stage which fetches executable instructions from memory, certain fetched instructions being load instructions (loads) and causing load operations, and other fetched instructions being store instructions (stores) and causing store operations;
an execution stage coupled to said fetch stage which executes the fetched instructions out of program order; and
logic coupled to said fetch and execution stages that detects a load/store order violation wherein a load executes prior to a store on whose data the load depends, creates a store set for the load, adds the store to the store set, determines whether the store is poisoned by a previously poisoned instruction, if the store is poisoned, sets a poison value that indicates that the store is poisoned, and re-processes said load if said poison value associated with said store indicates the store has been poisoned.

20. The microprocessor of claim 19 wherein said poison value comprises a bit in a table.

21. The microprocessor of claim 19 wherein the store set includes a pointer that points to the poison value.

22. The microprocessor of claim 19 wherein said store set includes a pair of tables which are used to identify said store instruction.

23. The microprocessor of claim 22 wherein said logic clears said poison value when said store is no longer poisoned.

24. A microprocessor, comprising:
a fetch stage which fetches instructions including a store instruction (store) and a load instruction (load) that target a common memory location; and
logic coupled to said fetch stage which determines if the data to be written by said store is stale, and if said data is stale, sets a value associated with said store and re-processes said load to execute after said data is no longer stale.

25. The microprocessor of claim 24 wherein said logic establishes a store set for said load to include said store.

26. The microprocessor of claim 25 wherein said logic uses said store set to access said value.

27. The microprocessor of claim 24 wherein said value comprises a poison bit.
